(19) United States
(12) Patent Application Publication
(10) Pub. No.: US 2026/0252308 A1
(43) Pub. Date: Aug. 27, 2026

(54) AVATAR MOVING APPARATUS

(71) Applicant: NTT DOCOMO, INC., Tokyo (JP)

(72) Inventors: Yoshiki INAGAKI, Chiyoda-ku (JP); Syouta SHIMAZAKI, Chiyoda-ku (JP); Kanako KUWANO, Chiyoda-ku (JP); Hisato SUGIYAMA, Chiyoda-ku (JP); Kouhei KAWASE, Chiyoda-ku (JP); Chisa YAMADA, Chiyoda-ku (JP)

(73) Assignee: NTT DOCOMO, INC., Tokyo (JP)

(21) Appl. No.: 19/127,191

(22) PCT Filed: Oct. 3, 2023
(86) PCT No.: PCT/JP2023/036108

§ 371 Date: May 5, 2025

(30) Foreign Application Priority Data
Nov. 11, 2022 (JP) 2022-180844

(51) Int. Cl. G06F 3/01; G06F 3/16; G06T 11/00

(52) U.S. Cl. CPC G06F 3/012; G06F 3/167; G06T 11/00

(57) ABSTRACT

A virtual space server includes a changer, a display controller, and a mover. The changer changes, when two or more facilities with the same facility name are present at a place on a destination of an avatar of a user specified by the user, the same facility name corresponding to the two or more facilities to two or more facility names that correspond one-to-one to the two or more facilities and differ from each other. The display controller displays on a display device used by the user, a display image including the two or more facility names different from each other that have been changed by the changer. The mover teleports, when the user has specified a first facility name included in the display image, the avatar of the user to a location corresponding to the first facility name.

### TECHNICAL FIELD

The present invention relates to avatar moving apparatuses that teleport avatars in a virtual space.

### BACKGROUND ART

A wearable system described in Patent Literature 1 controls virtual objects in an environment of a user, using a combination of a plurality of inputs, such as a head pose, an eye gaze, hand gestures, voice commands, and environmental factors in a wearable device. In addition, the wearable system controls the virtual objects using the voice commands based on speech of the user. For example, if the user says, “Move it there,” the wearable system determines an object to be moved and an intended destination.

### RELATED ART DOCUMENT

### Patent Document

Patent Literature 1: Japanese Patent Application Laid-open Publication No. 2022-121592

### SUMMARY OF THE INVENTION

### Problem to be Solved by the Invention

In a virtual space, such as a metaverse space, the user may establish a private room in the virtual space, or a system administrator may set up buildings in the virtual space. The private room and the buildings are examples of facilities at which avatars enter and leave in the virtual space. The name of a new facility thus established in the virtual space is usually determined by a person who has established the new facility. Accordingly, two or more facilities with the same name may exist in the virtual space.

When the facilities with the same name exist in the virtual space, there remains a problem that a destination of a virtual object cannot be uniquely identified by specifying the destination through conventional voice commands.

It is an object of the present disclosure to provide an avatar moving apparatus that allows a user to easily specify a destination of an avatar when a plurality of facilities with the same name exist in a virtual space.

### Means of Solving the Problems

An avatar moving apparatus according to the present disclosure comprises: a changer configured to change, when two or more facilities with a same facility name exist at a place on a destination of an avatar of a user specified by the user, the same facility name corresponding to the two or more facilities to two or more facility names that correspond one-to-one to the two or more facilities and differ from each other; a display controller configured to display on a display device used by the user, a display image including the two or more facility names different from each other that have been changed by the changer; and a mover configured to teleport, when the user has specified a first facility name included in the display image, the avatar of the user to a location corresponding to the first facility name.

### Effect of the Invention

According to present disclosure, a user can easily specify a destination facility of an avatar when facilities with the same name exist in a virtual space.

### BRIEF DESCRIPTION OF THE DRAWINGS

FIG. 1 is a block diagram illustrating an overall configuration of a virtual space system 1 according to an embodiment of the present disclosure.

FIG. 2A is an explanatory view for explaining a placement of an avatar Ak in a virtual space.

FIG. 2B is an explanatory view for explaining another placement of the avatar Ak in the virtual space.

FIG. 3 is a block diagram illustrating a configuration of a virtual space server 10.

FIG. 4 is an explanatory diagram illustrating a data structure of a user table TBL1.

FIG. 5 is an explanatory diagram illustrating a data structure of a first facility table TBL2.

FIG. 6 is an explanatory diagram illustrating a map.

FIG. 7A is an explanatory diagram illustrating a data structure of a second facility table TBL3 before being updated.

FIG. 7B is an explanatory diagram illustrating a data structure of the second facility table TBL3 after being updated.

FIG. 8 is a block diagram illustrating a configuration of a user device 20-k.

FIG. 9 is a flowchart illustrating operation of the virtual space server 10.

FIG. 10 is an explanatory diagram illustrating a display image generated by a display controller 116 according to a third modification of the embodiment.

FIG. 11 is an explanatory diagram illustrating a display image generated by the display controller 116 according to a fourth modification of the embodiment.

### MODES FOR CARRYING OUT THE INVENTION

### 1: Embodiments

The following describes a virtual space system 1 with reference to the drawings.

### 1.1: Configuration of Embodiment

### 1.1.1: Overall Configuration

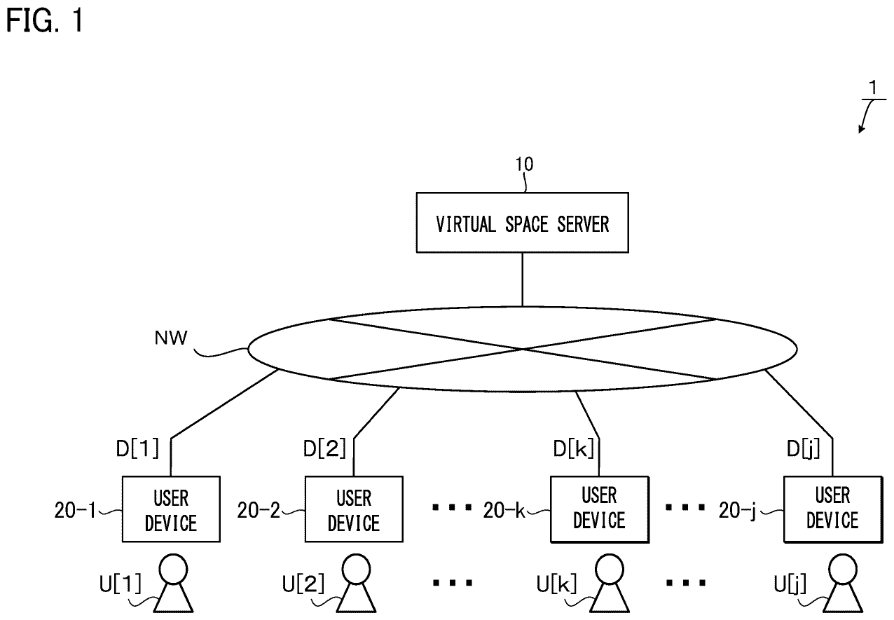

FIG. 1 is a block diagram illustrating an overall configuration of the virtual space system 1 according to an embodiment of the present disclosure. As illustrated in FIG. 1, the virtual space system 1 includes a virtual space server 10 and user devices 20-1, 20-2, . . . , 20-k, . . . , 20-j. k is any integer from 1 to j. The user devices 20-1, 20-2, . . . , 20-k, . . . , 20-j are used by users U[1], U[2], . . . , U[k], . . . , U[j]. The virtual space server 10 is mutually communicably connected to the user devices 20-1, 20-2, . . . , 20-j via a network NW.

The user device 20-k is an information processing device with a function to display images, such as a personal computer, a tablet, a smartphone, or a head-mounted display. The user device 20-k may be configured as a combination of the tablet or the smartphone and the head-mounted display.

If the user device 20-k includes the head-mounted display, the user device 20-k provides the user U[k] with an image indicating a portion of a three-dimensional virtual space. If the user device 20-k does not include the head-mounted display, the user device 20-k provides the user U[k] with an image indicating a portion of a two-dimensional virtual space.

The virtual space server 10 provides a virtual space service. The virtual space server 10 is an example of an avatar moving apparatus. The user U[k] subscribes to the virtual space service. In the virtual space service, an avatar used by the user U[k] can be teleported in the virtual space. The user U[k] can also specify the destination of the avatar used by the user by voice. The avatar is a character used as the alter ego of the user in the virtual space. The virtual space refers to all space that can be provided by the virtual space service. That is, a space visible to the avatar is a part of the virtual space.

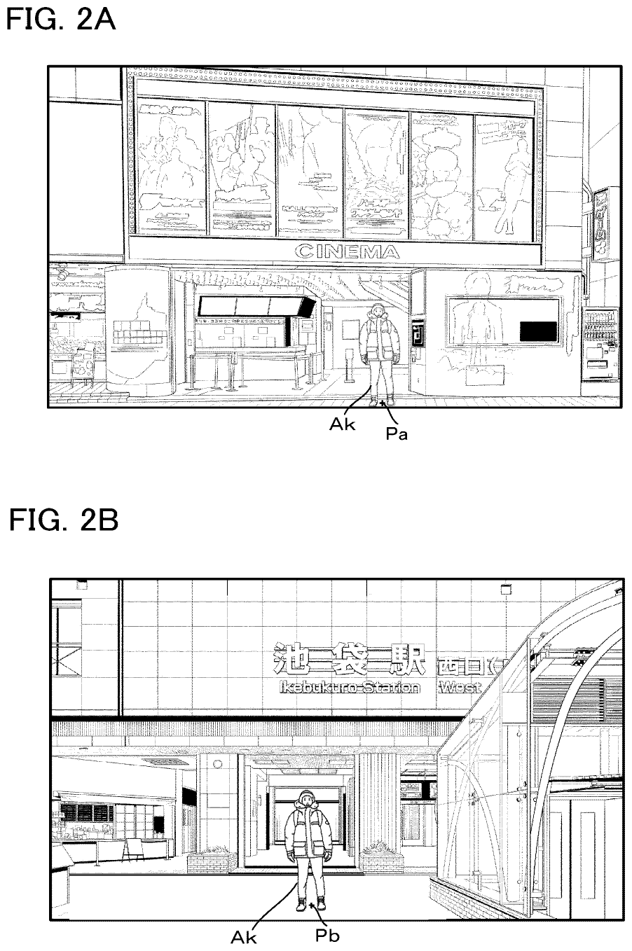

It is envisaged that an avatar Ak of the user U[k] is located at the entrance of a cinema as illustrated in FIG. 2A, and user U[k] specifies, by speaking, a movement to Ikebukuro Station. In this case, the avatar Ak of the user U[k] is teleported to Ikebukuro Station as illustrated in FIG. 2B.

### 2: Configuration of Virtual Space Server 10

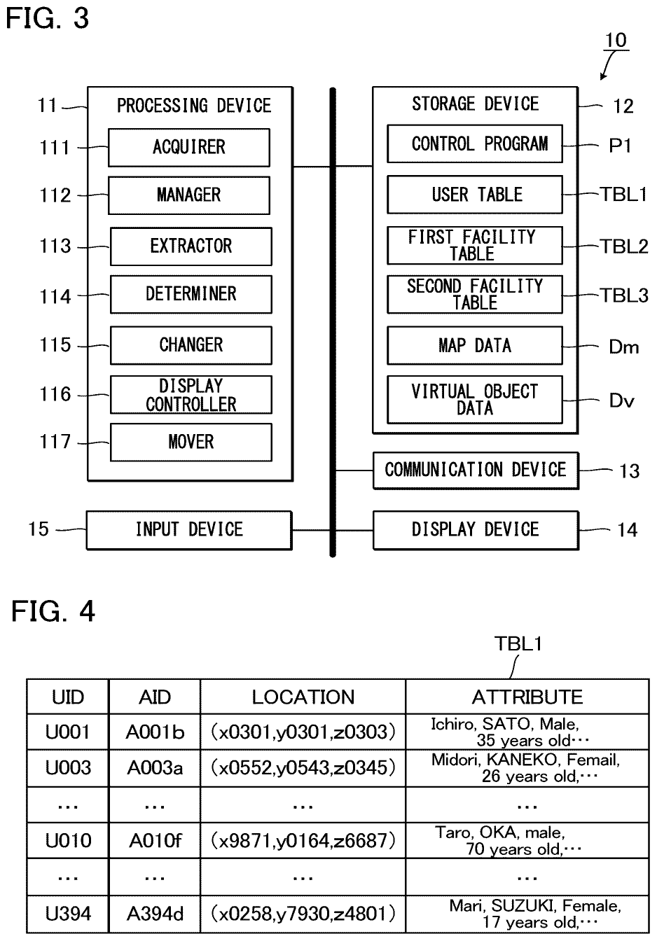

FIG. 3 is a block diagram illustrating a configuration of the virtual space server 10. As illustrated in FIG. 3, the virtual space server 10 includes a processing device 11, a storage device 12, a communication device 13, a display device 14, and an input device 15. The components included in the virtual space server 10 are interconnected by a single bus or buses for communicating information. The term “device” in this specification may be replaced with another term such as “circuit” or “unit”.

The processing device 11 is a processor that controls the entire virtual space server 10. The processing device 11 may comprise one or more chips. The processing device 11 may also comprise a central processing unit (CPU) that includes interfaces with peripheral devices, arithmetic devices, and registers. One, some, or all functions included in the processing device 11 may be performed by hardware, such as a digital signal processor (DSP), an application-specific integrated circuit (ASIC), a programmable logic device (PLD), and/or a field-programmable gate array (FPGA). The processing device 11 executes a variety of processes in parallel or in a sequential way.

The storage device 12 is a recording medium that is read from and is written to by the processing device 11. The storage device 12 includes, for example, a non-volatile memory and a volatile memory. Examples of the non-volatile memory include, but are not limited to, a read-only memory (ROM), an erasable programmable read-only memory (EPROM), and an electrically erasable programmable read-only memory (EEPROM). In one example, the volatile memory is a random-access memory (RAM). The storage device 12 stores therein a control program P1 executed by the processing device 11 and various types of data including a user table TBL1, a first facility table TBL2, a second facility table TBL3, map data Dm, and virtual object data Dv. The storage device 12 also serves as a work area for the processing device 11.

The user table TBL1 stores therein data related to the users of the virtual space service. The user table TBL1 stores therein a user identifier UID (hereinafter, “UID”) that identifies the user, an avatar identifier AID (hereinafter, “AID”) that identifies the avatar used by the user, a location of the avatar in the virtual space, an attribute of the user, and an action history of the avatar, so as to be associated with one another. The attributes of the user include at least one of a name, a gender, an age, hobbies, an address, an occupation, and a place of work.

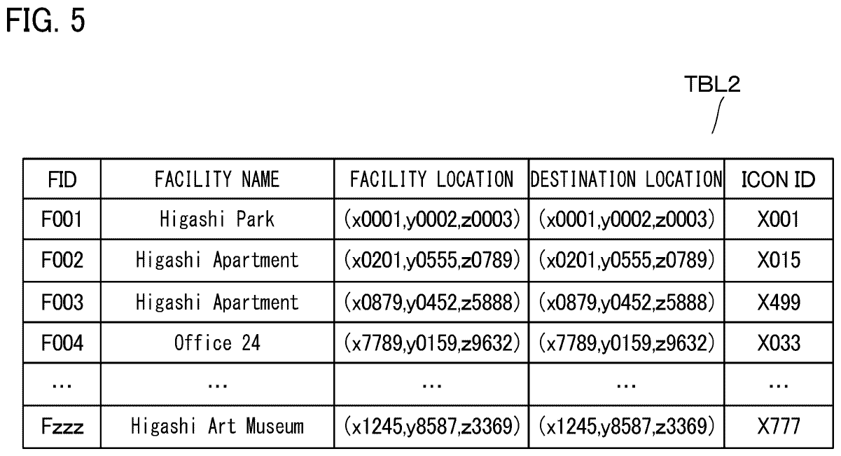

FIG. 4 is an explanatory diagram illustrating a data structure of the user table TBL1. By referring to the user table TBL1, the processing device 11 knows where the avatar of the user who has logged into the virtual space service is located in the virtual space. According to the user table TBL1 illustrated in FIG. 4, the processing device 11 understands that the user with the UID “U001” has logged in; the AID of the avatar used by the user is “A001b”; and the avatar is located at (x0301, y0301, z0303).

The first facility table TBL2 illustrated in FIG. 3 manages facilities in the virtual space. The first facility table TBL2 stores therein a facility identifier (ID) (hereinafter, “FID”), a facility name, a facility location that indicates the location of the facility, a destination location, and an icon ID that identifies an icon corresponding to the facility, so that they are associated with one another. The destination location is a location serving as a target to which the avatar is to be teleported when the facility is specified as the destination of the avatar. For example, when the facility is a museum of art, the destination location indicates coordinates of an open space near the entrance of the museum of art. The destination location is a location serving as a target to move to, and the avatar is not necessarily teleported to the destination location. If another avatar is located at the destination location, the avatar to be teleported is teleported to a location that is near the destination location and does not overlap the other avatar. The first facility table TBL2 is an example of first facility data that associates the facility name of a facility with the location of the facility for each of the multiple facilities located in the virtual space.

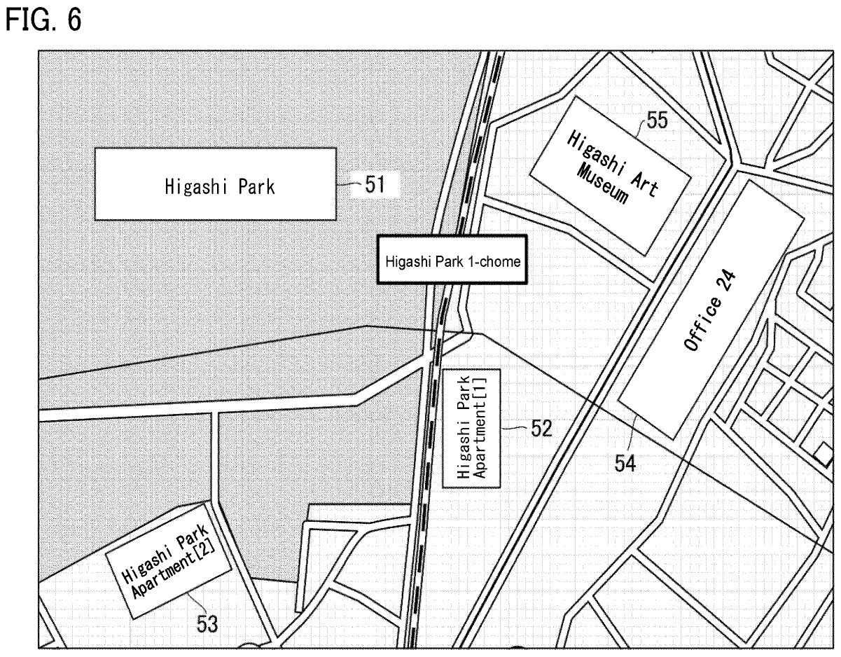

FIG. 5 is an explanatory diagram illustrating a data structure of the first facility table TBL2. By referring to the first facility table TBL2, the processing device 11 can understand the facilities in the virtual space. According to the first facility table TBL2 illustrated in FIG. 5, the processing device 11 understands that the facility name corresponding to the FID “F001” is Higashi Park, and the facility location corresponding to the FID “F001” is (x0001, y0002, z0003).

The second facility table TBL3 illustrated in FIG. 3 is used to manage two or more facilities with the same facility name, when two or more facilities with the same facility name exist in a place (area) on the destination of the avatar Ak specified by the user U[k]. The second facility table TBL3 is an example of second facility data. Details of the second facility table TBL3 will be described later.

The map data Dm associates a place name, coordinates indicating the center location of the place name, and image data illustrating the map with one another. The virtual object data Dv is data that three-dimensionally represents virtual objects. The virtual objects include moving objects, such as avatars and vehicles, that move by themselves in the virtual space, and fixed objects, such as buildings, that do not move by themselves in the virtual space. The virtual objects include virtual objects that represent icons used in maps.

The communication device 13 is hardware that serves as a transmitting and receiving device to communicate with other devices. The communication device 13 is also called a network device, a network controller, a network card, a communication module. The communication device 13 may include a connector for wired connection and a wireless communication interface. Examples of the connector for wired connection and an interface circuit include, but are not limited to, products compliant with a wired local area network (LAN) standard, the Institute of Electrical and Electronics Engineers (IEEE) standard 1394, and the Universal Serial Bus (USB) standard. Examples of the wireless communication interface include, but are not limited to, products compliant with a wireless LAN standard and the Bluetooth (registered trademark) standard.

The display device 14 displays images. The display device 14 displays a variety of images under the control of the processing device 11.

The input device 15 receives input operations of an administrator of the server. The input device 15 outputs operation signals in response to the operations of the administrator to the processing device 11. In one example, the input device 15 includes a keyboard and a pointing device.

In such a configuration, the processing device 11 reads out the control program P1 from the storage device 12. The processing device 11 serves as an acquirer 111, a manager 112, an extractor 113, a determiner 114, a changer 115, the display controller 116, and a mover 117, by executing the control program P1.

The acquirer 111 acquires voice data D[1], D[2], . . . , D[k], . . . , D[j] transmitted from the user devices 20-1, 20-2, . . . , 20-k, . . . , 20-j via the communication device 13. The voice data indicates content of speech of the users U[1], U[2], . . . , U[k], . . . , U[j].

Using the user table TBL1, the manager 112 manages the data related to the user who has logged into the virtual space service. Specifically, the manager 112 manages the UID of the logged-in user, the AID of the avatar used by the user, and the location of the avatar. In one example, if the avatar has been teleported, the manager 112 writes, into the user table TBL1, the location of the avatar after having moved. If the user has logged out of the virtual space service, the manager 112 deletes a record corresponding to the logged-out user from the user table TBL1.

The manager 112 manages the facilities located in the virtual space using the first facility table TBL2. Specifically, if a new facility is disposed in the virtual space, the manager 112 adds a record corresponding to the new facility to the first facility table TBL2. In contrast, if a facility is deleted from the virtual space, the manager 112 deletes records corresponding to the deleted facility from the first facility table TBL2.

The extractor 113 extracts the facility names associated with the place on the destination of the avatar Ak specified by the user U[k] based on the first facility table TBL2.

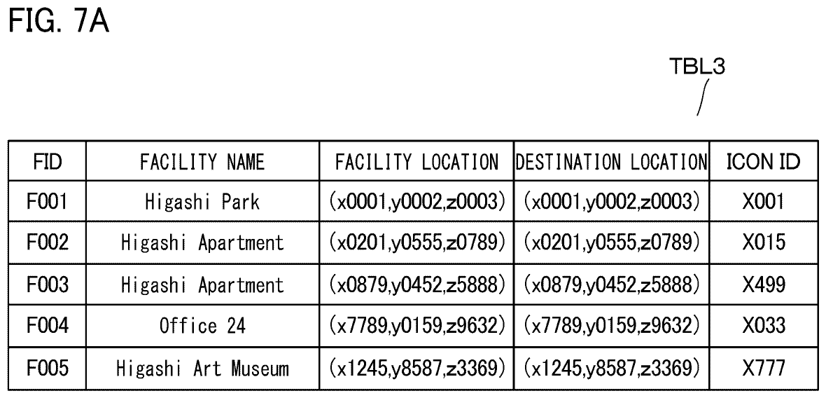

When the user U[k] teleports the avatar Ak, the user U[k] needs to identify coordinates of a location of an eventual destination in the virtual space. The user U[k] specifies the destination by voice. As described above, the facility name and the destination location are stored in the first facility table TBL2 so as to be associated with each other. For this reason, if the name of the facility serving as the destination of the avatar Ak can be uniquely identified, the destination location of the avatar Ak can be identified. However, the user U[k] does not necessarily recognize the facility name of the destination facility. In addition, two or more facilities with the same facility name may exist in the virtual space. Thus, the virtual space system 1 displays a map containing the multiple facility names on the user device 20-k of the user U[k]. By displaying the map, the user U[k] can recognize the name of the facility serving as the destination of the avatar Ak by voice. Specifically, the user U[k] specifies the place on the destination of the avatar Ak. The place on the destination may include more than one facility. In one example, if the user U[k] says, “Display a map of Higashi Park 1-chome,” a map illustrated in FIG. 6 is displayed. “Higashi Park 1-chome” corresponds to the place at the destination of the avatar Ak.

The extractor 113 illustrated in FIG. 3 recognizes the place at the destination of the avatar Ak based on the voice data D[k] acquired from the user device 20-k by the acquirer 111. The extractor 113 identifies the center of the place on the destination of the avatar Ak by referring to the map data Dm. The extractor 113 identifies a predetermined area centered on the identified center location. In one example, the predetermined area is an area of 700 m on an axis along the east-west direction by 500 m on an axis along the north-south direction. The extractor 113 generates the second facility table TBL3 by extracting records of the facilities belonging to the predetermined area by referring to the first facility table TBL2. The second facility table TBL3 is stored in the storage device 12. The second facility table TBL3 includes five icons 51 to 55 corresponding to five facilities.

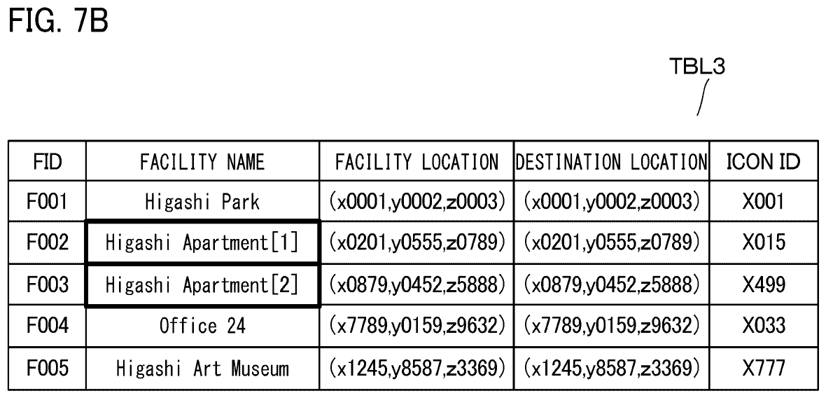

FIG. 7A is an explanatory diagram illustrating a data structure of the second facility table TBL3. The second facility table TBL3 illustrated in FIG. 7A corresponds to the case where the user U[k] says, “Display a map of Higashi Park 1-chome.” In this example, the extractor 113 extracts, as the facilities associated with “Higashi Park 1-chome” that is the place at the destination of the avatar Ak, a set of the FID “F001” and the facility name “Higashi Park”, a set of the FID “F002” and the facility name “Higashi Apartment”, a set of the FID “F003” and the facility name “Higashi Apartment”, a set of the FID “F004” and the facility name “Office 24”, and a set of the FID “F005” and the facility name “Higashi Art Museum”.

The determiner 114 illustrated in FIG. 3 determines whether the names of the facilities extracted by the extractor 113 include the same facility name. In the example the facility name for the FID “F002” and the FID “F003” is “Higashi Apartment”. As a result, the determination result of the determiner 114 is affirmative.

When two or more facilities with the same facility name are present at the place at the destination of the avatar of the user specified by the user, the changer 115 changes the name of the two or more facilities to two or more facility names different from each other. Specifically, the changer 115 updates the stored content of the second facility table TBL3 by writing two or more changed facility names different from each other into the second facility table TBL3, using the manager 112.

In the second facility table TBL3 illustrated in FIG. 7A, the facility name for the FID “F002” and the FID “F003” is “Higashi Apartment”. In this case, the changer 115 updates the stored content of the second facility table TBL3. FIG. 7B is an explanatory diagram illustrating a data structure of the updated second facility table TBL3. In the second facility table TBL3 illustrated in FIG. 7B, the facility name corresponding to the FID “F002” has been changed to “Higashi Apartment [1]” and the facility name corresponding to the FID “F002” has been changed to “Higashi Apartment [2]”.

The display controller 116 illustrated in FIG. 3 displays on the user device 20-k used by the user U[k], a display image including the two or more facility names different from each other that have been changed by the changer 115. The display controller 116 generates the display image including the facility names different from each other for the respective facilities stored in the updated second facility table TBL3. The facilities stored in the updated second facility table TBL3 include facilities with names that have been changed by the changer 115. Thus, the display image includes two or more facility names different from each other that have been changed by the changer 115.

In one example, this display image represents a map. The image of the map includes the facility names that correspond one-to-one to the facilities stored in the second facility table TBL3 and two or more icons that correspond one-to-one to the facilities. The facilities stored in the updated second facility table TBL3 include the facilities with the names having been changed by the changer 115. Thus, the image of the map includes the two or more facility names changed by the changer 115 that correspond one-to-one to the two or more facilities, and the two or more icons that correspond one-to-one to the two or more facilities. The icons are identified by the icon IDs stored in the second facility table TBL3, and the locations of the icons are identified by the facility locations stored in the second facility table TBL3. When the display controller 116 generates the image of the map based on the second facility table TBL3 illustrated in FIG. 7B, the display controller 116 generates the image of the map illustrated in FIG. 6.

The display controller 116 transmits the image data illustrating the generated image of the map to the user device 20-k via the communication device 13. By transmitting the image data, the display controller 116 displays the display image on the user device 20-k used by the user U[k].

When the user U[k] has specified a first facility name included in the display image, the mover 117 teleports the avatar Ak of the user U[k] to a location corresponding to the first facility name. Specifically, the mover 117 recognizes the first facility name based on the voice data D[k] acquired from the user device 20-k by the acquirer 111. The mover 117 identifies the destination location corresponding to the first facility name by referring to the updated second facility table TBL3. The mover 117 teleports the avatar Ak of the user U[k] to the identified destination location. The mover 117 uses the manager 112 to update the location of the avatar to the destination location, for a record among a plurality of records stored in the user table TBL 1 that corresponds to the user U[k].

### 1.1.3: Configuration of User Device

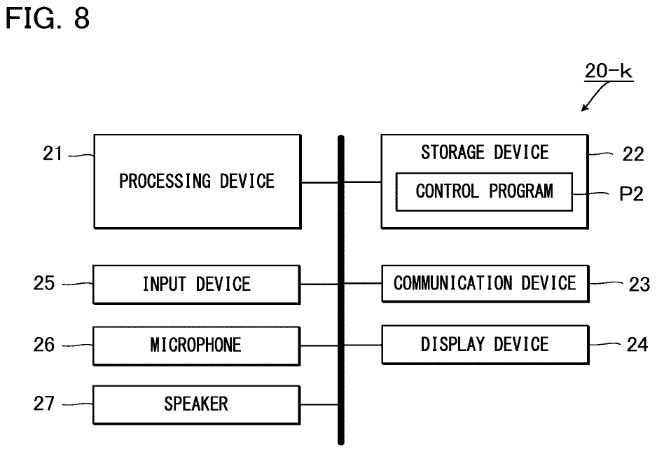

FIG. 8 is a block diagram illustrating a configuration of the user device 20-k. The user device 20-k includes a processing device 21, a storage device 22, a communication device 23, a display device 24, an input device 25, a microphone 26, and a speaker 27. The components of the user device 20-k are interconnected by a single bus or by a plurality of buses for communicating information. The user device 20-k is an example of a display control device.

The processing device 21 is a processor that controls the entire user device 20-k. The processing device 21 comprises one or more chips. The processing device 21 may also comprise a central processing unit (CPU) that includes interfaces with peripheral devices, arithmetic devices, registers, and the like. One, some, or all functions included in the processing device 21 may be performed by hardware such as a DSP, an ASIC, a PLD, and/or an FPGA. The processing device 21 executes a variety of processes in parallel or sequentially.

The storage device 22 is a recording medium that is read from and written to by the processing device 21. The storage device 22 stores therein a plurality of programs, including a control program P2 executed by the processing device 21. The storage device 22 also serves as a work area for the processing device 21.

The communication device 23 is hardware that serves as a transmitting and receiving device to communicate with other devices. The communication device 23 is also called a network device, a network controller, a network card, and a communication module. The communication device 23 includes a connector for wired connection; however, it may include an interface circuit corresponding to the connector. The communication device 23 may also include a wireless communication interface.

The display device 24 is a device that displays images. The display device 24 displays a variety of images under the control of the processing device 21. When the user device 20-k is a head-mounted display, the display device 24 includes a display for the left eye and a display for the right eye. Displaying different images on the two displays according to parallax allows the user U[k] to perceive a three-dimensional image.

The input device 25 receives input operations of the user U[k]. The input device 25 outputs operation signals in response to the operations of the user U[k] to the processing device 21. The input device 25 may be a touchscreen. The input device 25 may be a controller that is held and used by the user U[k]. The controller outputs the operation signals in response to the operations of the user U[k] to the processing device 21. The input device 25 may also include an imaging device. When the input device 25 includes the imaging device, the input device 25 detects a gesture of the user U[k] based on an image captured by the imaging device, and outputs an operation signal indicating the detected gesture to the processing device 21. When the input device 25 includes the imaging device, the input device 25 detects the line of sight of the user U[k] based on an image of the eyes of the user U[k] captured by the imaging device, and outputs an operation signal indicating the direction of the line of sight to the processing device 21.

The microphone 26 converts sound into an electrical signal. The microphone 26 includes a digital-to-analog (DA) convertor. The microphone 26 converts the sound based on the speech of the user U[k] into a voice signal, and converts the voice signal into the voice data D[k] using the DA convertor. The voice data D[k] is output to the processing device 21.

The speaker 27 converts an electrical signal into sound. The speaker 27 includes an analog-to-digital (AD) convertor. Sound data output from the processing device 21 is converted into a sound signal by the AD convertor. The speaker 27 converts the received sound signal into sound and emits the sound. The speaker 27 may be a pair of built-in earphones.

### 2: Operation of Virtual Space Server 10

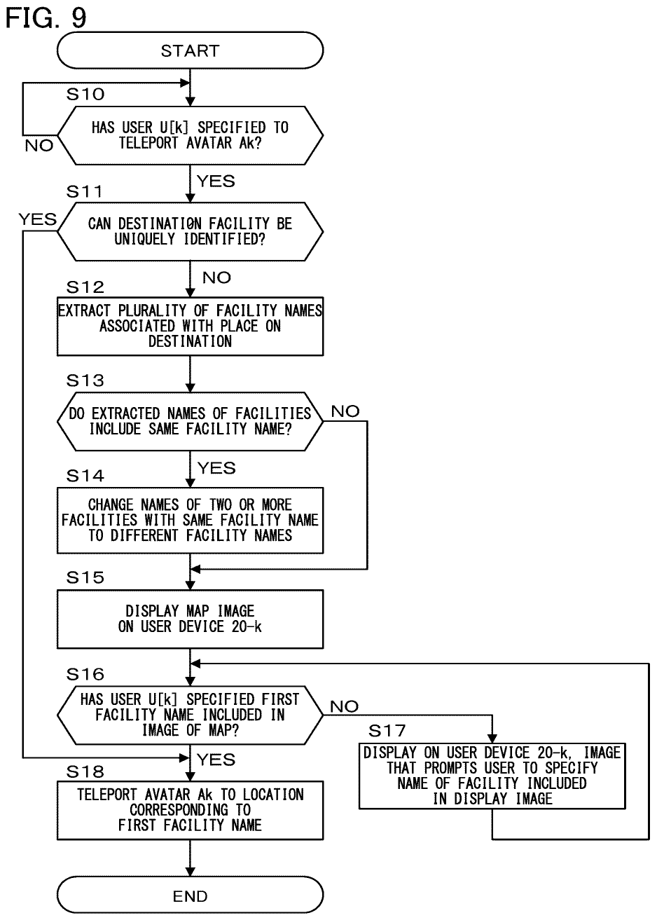

The following describes operation of the virtual space server 10. In this example, it is assumed that the user U[k] teleports the avatar Ak. FIG. 9 is a flowchart illustrating an operation of the virtual space server 10.

At Step S10, the processing device 11 determines whether the user U[k] has specified to teleport the avatar Ak based on the voice data D[k] received via the communication device 13. In one example, if a voice represented by the voice data D[k] contains the words “move” and “avatar”, the processing device 11 determines that the user U[k] has specified to teleport the avatar Ak. The processing device 11 repeats the determination at Step S10 until the determination result at Step S10 becomes affirmative. If the determination result at Step S10 is affirmative, the processing device 11 moves the process to Step S11.

At Step S11, the processing device 11 determines, based on the voice data D[k], whether the destination facility specified by the user U[k] can be uniquely identified. Specifically, the processing device 11 determines whether the facility name included in the voice represented by the voice data D[k] is included among the facility names stored in the first facility table TBL2, and the number of the FIDs corresponding to the facility name included in the voice is one.

When the determination result at Step S11 is affirmative, the processing device 11 moves the process to Step S18. When the determination result at Step S11 is negative, the processing device 11 moves the process to Step S12. In one example, if the voice represented by the voice data D[k] includes the place on the destination of the avatar Ak instead of the facility name, the determination result at Step S11 is negative. In one example, the place on the destination indicates a place name for identifying an address, such as “Higashi Park 1-chome” or “Ginza”. If the voice represented by the voice data D[k] does not include the place on the destination, such as “Teleport the avatar,” the determination result at Step S11 is negative. If the voice represented by the voice data D[k] does not include the place at the destination, the processing device 11 may generate a message such as “Please specify the destination of the avatar,” and transmit the generated message to the user device 20-k. This message may be either voice or an image.

At Step S12, the processing device 11 extracts a plurality of the facility names associated with the place on the destination of the avatar Ak specified by the user U[k]. Specifically, the processing device 11 recognizes the place at the destination of the avatar Ak based on the voice data D[k]. The processing device 11 identifies the center of the place at the destination of the avatar Ak by referring to the map data Dm. The processing device 11 identifies the predetermined area centered on the identified center location.

The processing device 11 extracts the records of the facilities belonging to the predetermined area by referring to the first facility table TBL2. The processing device 11 generates the second facility table TBL3 including the extracted records. The processing device 11 stores the second facility table TBL3 in the storage device 12.

At Step S13, the processing device 11 determines whether the extracted records of the facilities include the same facility name. Specifically, the processing device 11 determines whether two or more records recording the same facility name exist in the second facility table TBL3.

When the determination result at Step S13 is affirmative, the processing device 11 moves the process to Step S14. When the determination result at Step S13 is negative, the processing device 11 moves the process to Step S15.

At Step S14, when two or more facilities with the same facility name exist, the processing device 11 changes the names of the two or more facilities to two or more different facility names. Specifically, the processing device 11 updates the stored content of the second facility table TBL3 by writing the two or more changed facility names different from each other into the second facility table TBL3.

At Step S15, the processing device 11 displays the image of the map on the user device 20-k to display. The processing device 11 generates the display image including the facility names different from each other for the respective facilities by referring to the updated second facility table TBL3. The updated second facility table TBL3 includes the facility names that were changed at Step S14. Thus, the image of the map includes the two or more changed facility names. The processing device 11 transmits the image data illustrating the generated image to the user device 20-k via the communication device 13.

At Step S16, the processing device 11 determines whether the user U[k] has specified the first facility name included in the image of the map by voice. The processing device 11 recognizes the first facility name based on the voice data D[k]. The processing device 11 determines whether the recognized first facility name is stored in the updated second facility table TBL3.

When the determination result at Step S16 is negative, the processing device 11 moves the process to Step S17. If the user U[k] has not said the facility name included in the image of the map as the first facility name, the determination result at Step S16 is negative. In one example, when the image of the map illustrated in FIG. 6 is displayed on the user device 20-k, if the user U[k] says, “Move the avatar to the central station,” while the central station is not included in the map, the determination result at Step S16 is negative.

At Step S17, the processing device 11 displays on the user device 20-k, an image that prompts the user to specify a name of a facility included in the display image. The processing device 11 generates image data illustrating a text such as “Please specify a facility name included in the map,” and transmits the generated image data to the user device 20-k via the communication device 13. When the process at Step S17 ends, the processing device 11 returns the process to Step S16.

When the determination result at Step S16 is affirmative, the processing device 11 moves the process to Step S18. At Step S18, the processing device 11 teleports the avatar Ak to a location corresponding to the first facility name. The processing device 11 identifies the facility location corresponding to the first facility name by referring to the second facility table TBL3. The processing device 11 teleports the avatar Ak to the identified facility location. The processing device 11 accesses the user table TBL1 and writes the identified facility location to an avatar location corresponding to the UID of the user U[k]. The processing device 11 generates image data for displaying a part of the virtual space including the identified facility location based on the virtual object data Dv, and transmits the generated image data to the user device 20-k. The user device 20-k displays the virtual space of the identified facility location on the display device 24 based on the received image data. This display allows the user U[k] to recognize that the avatar Ak has been teleported to the destination facility.

In the foregoing processing, the processing device 11 serves as the acquirer 111 at Step S10. The processing device 11 serves as the extractor 113 at Step S12. The processing device 11 serves as the determiner 114 at Step S13. The processing device 11 serves as the changer 115 at Step S14. The processing device 11 serves as the display controller 116 at Step S15. The processing device 11 serves as the mover 117 at Step S18.

### 1.3: Effects Produced by Embodiment

According to the foregoing description, the virtual space server 10 includes the changer 115 that changes, when two or more facilities with the same facility name exist at the place on the destination of the avatar Ak of the user U[k] specified by the user U[k], the names of the two or more facilities to two or more different facility names. The virtual space server 10 further includes the display controller 116 that displays on the user device 20-k used by the user U[k], the display image including the two or more facility names different from each other that have been changed by the changer 115. The virtual space server 10 further includes the mover 117 that teleports, when the user U[k] has specified the first facility name included in the display image, the avatar Ak of the user U[k] to a location corresponding to the first facility name.

Since the virtual space server 10 has the configuration described above, when two or more facilities with the same facility name exist at the place at the destination of the avatar, the virtual space server 10 changes the facility names of these facilities to facility names different from each other. Furthermore, the virtual space server 10 displays the changed facility names on the user device 20-k. As a result, the user U[k] can visually recognize the different facility names that serve as candidate destinations. The user U[k] can easily specify the facility that serves as the destination.

The first facility name is preferably specified by voice of the user U[k]. In this case, the destination facility can be uniquely identified by the voice of the user U[k], and the avatar Ak can be teleported to the identified facility.

The display image may represent a map. The image of the map includes the two or more facility names changed by the changer 115 that correspond one-to-one to the two or more facilities, and the two or more icons that correspond one-to-one to the two or more facilities.

Since the image of the map is displayed on the user device 20-k, the user U[k] can visually understand the locations of the two or more facilities even when the two or more facilities with the same facility name are present. For the two or more facilities with the same facility name, the facility names of the two or more facilities are changed to two or more facility names different from each other and displayed on the map. As a result, the user U[k] can easily specify the destination facility.

The virtual space server 10 includes the extractor 113 that extracts the facility names of a plurality of facilities associated with a place based on the first facility table TBL2 that associates the facility name of a facility with the location of the facility for each of the facilities located in the virtual space and the determiner 114 that determines whether the names of the facilities extracted by the extractor 113 include the same facility name. When the determination result of the determiner 114 is affirmative, the changer 115 changes each of the two or more facilities to two or more different facility names.

Since the first facility table TBL2 associates the facility name of each of the facilities located in the virtual space with the location of the facility, the facilities located in the virtual space are managed in a centralized way. As a result, the processing load to extract the facility names of the facilities associated with the place is reduced compared with a case of managing the relation between the facility name of the facility and the location of the facility for each of the facilities in a distributed manner.

The virtual space server 10 includes the manager 112 that manages the second facility table TBL3 and the first facility table TBL2, the second facility table TBL3 associating the facility names of two or more different facilities changed by the changer 115 with the locations of the two or more different facilities in a one-to-one manner.

When the first facility name is one of two or more different facility names changed by the changer 115, the mover 117 identifies the location of the facility corresponding to the first facility name based on the second facility table TBL3.

The virtual space server 10 has the second facility table TBL3, and therefore, can display the different facility names on the user device 20-k without changing the content of the first facility table TBL2. In particular, if an installer who has installed a facility in the virtual space can determine the facility name of the facility, the virtual space server 10 can manage the facility name using the first facility table TBL2, while providing the user U[k] with a uniquely identifiable facility name, using the second facility table TBL3.

### 2. Modifications

The present disclosure is not limited to the foregoing embodiment. The following illustrates specific aspects of modifications. Two or more of the aspects freely selected from the following illustrations may be combined.

### 2.1: First Modification

In the foregoing embodiment, the virtual space server 10 generates the images in the virtual space and transmits the generated images to the user device 20-k, but the present disclosure is not limited thereto. The virtual space server 10 manages the location of the avatar Ak of the user U[k], using the user table TBL1. The virtual space server 10 may transmit data on fixed virtual objects located in the virtual space around a location of an avatar to the user device 20-k in advance, and then transmit an image of a virtual object, such as the avatar Ak, that moves in location to the user device 20-k. The user device 20-k manages the images related to the fixed virtual objects and the image related to the moveable virtual object in layers different from each other. Furthermore, the user device 20-k may generate an image in which the layers are superimposed, and display the generated image on the display device 24. The virtual space server 10 can save communication resources by transmitting the images managed in layers.

### 2.2: Second Modification

Two or more facilities may be present that have the same facility name as the facility name specified by the user U[k] as the destination, and these two or more facilities may be located at locations that are too far apart to be displayed on one map. In this case, the display controller 116 may generate two or more maps that correspond one-to-one to the two or more facilities, and transmit image data illustrating an image including the two or more maps to the user device 20-k.

### 2.3: Third Modification

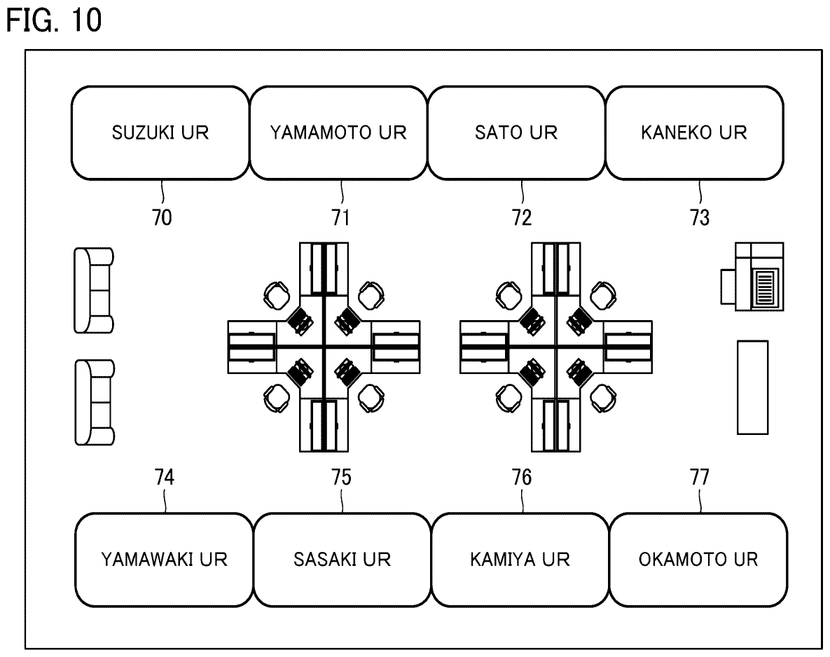

In the foregoing embodiment, when the two or more facilities with the same facility name exist at the place on the destination of the avatar Ak of the user U[k], the changer 115 changes the names of the two or more facilities to the two or more different facility names. The changer 115 may change the names of the two or more facilities to a facility name including the facility name before the change and the name of a manager of the facility. It is envisaged that a private room for each employee is located in an office located in the virtual space. Suppose that two or more private rooms arranged in the office have a common facility name “UR (User Room)”. In this case, the changer 115 may change the facility name to a name that combines the facility name before the change with the family name of the employee (user). The employee (user) is an example of the manager of the facility. FIG. 10 is an explanatory diagram illustrating an example of the display image generated by the display controller 116 according to a third modification of the embodiment. The display image illustrated in FIG. 10 includes icons 70 to 77 indicating the private rooms and the facility names that each combine the facility name before the change “UR” with the family name of the employee. Since each of the two or more different facility names changed by the changer 115 in this way includes the facility name before the change and the name of the manager of the facility, the user U[k] can easily specify the name of the destination facility based on the displayed image.

### 4: Fourth Modification

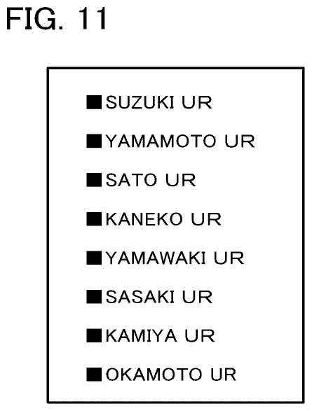

In the foregoing embodiment, the display image represents a map including the icons corresponding one-to-one to the facilities and the facility names corresponding one-to-one to the facilities. The present disclosure is not limited thereto. The display image may be a list of facility names corresponding one-to-one to facilities arranged at the place at the destination of the avatar Ak of the user U[k]. FIG. 11 is an explanatory diagram illustrating an example of the display image generated by the display controller 116 according to a fourth modification of the embodiment. The display image illustrated in FIG. 11 illustrates a list of the facility names included in the display image illustrated in FIG. 10. By illustrating the names of these facilities in a list format, the display area can be reduced.

### 2.5: Fifth Modification

In the foregoing embodiment, the user U[k] specifies, by voice, the first facility name serving as the destination of the avatar Ak from among the facility names included in the display image, but the present disclosure is not limited thereto. The user U[k] may use any method to specify the name of the first facility name. The first facility name may be specified by the line of sight of the user U[k]. When the line of sight is used, the user device 20-k may detect the direction of the line of sight of the user U[k] using the input device 25, identify a facility name in the display image located in the detected direction as the first facility name, and transmit the first facility name to the virtual space server 10. The first facility name may be specified by an operation of the user U[k] onto the controller. The operation of the user U[k] may be detected using the controller as the input device 25, by detecting the operation, the facility name in the display image may be identified as the first facility name, and the first facility name may be transmitted to the virtual space server 10. When specifying the first facility name using the controller, the first facility name may be specified by an operation of moving the cursor right and left as the facility name serving as the destination of the avatar Ak from among the facility names included in the display image. The first facility name may be specified by displaying the facility names included in the display image as numbers, and allowing the user U[k] to input the number of the facility serving as the destination of the avatar Ak using the controller.

### 3. Other Matters

(1) In the foregoing embodiment, a read only memory (ROM) and a random access memory (RAM) are exemplified as the memory devices 12 and 22, but these memory devices are flexible disks, magneto-optical disks (for example, compact discs, digital versatile discs, or Blu-ray (registered trademark) discs), smart cards, flash memory devices (for example, cards, sticks, or key drives), compact disc-ROMs (CD-ROMs), registers, removable disks, hard disks, floppy (registered trademark) disks, magnetic strips, databases, servers, or other appropriate storage media. The program may be transmitted from a network via an electric communication line. The program may be transmitted from the communication network NET via the electric communication line.

(2) Information, signals, or the like described in the embodiment may be represented by using any of various different technologies. For example, data, instruction, command, information, signal, bit, symbol, chip, or the like that may be mentioned throughout the entirety of the above description may be represented by voltage, current, electromagnetic wave, magnetic field or magnetic particle, optical field or photons, or an optional combination thereof.

(3) In the foregoing embodiment, Input and output information and the like may be stored in a specific location (for example, a memory) or may be managed using a management table. Information and the like to be input and output may be overwritten, updated, or added. Output information and the like may be deleted. Input information and the like may be transmitted to another device.

(4) In the foregoing embodiment, determination may be made based on a value (0 or 1) expressed by one bit, based on a truth value (Boolean: true or false), or based on comparison of numerical values (for example, comparison with a predetermined value). (5) The order of processing procedures, sequences, and flowcharts in the embodiment may be rearranged as long as there is no contradiction. For example, the method described in the present disclosure presents elements of various steps using an exemplary order and is not limited to the presented specific order.

(6) These functional blocks are realized by an optional combination of at least one of hardware and software. The method for realizing each functional block is not particularly limited to any specific method. That is, each functional block may be realized by using one device combined physically or logically, or realized by directly or indirectly connecting (for example, using wired or wireless communication) two or more devices physically or logically separated from each other and using these plural devices. Each functional block may be realized by combining software with one or more devices described above.

(7) Regardless of whether program is referred to as software, firmware, middleware, microcode, or hardware description language, or some other name, the program should be interpreted broadly to mean instruction, instruction set, code, code segment, program code, program, subprogram, software module, application, software application, software package, routine, subroutine, object, executable file, execution thread, procedure, function, and the like.

Software, instruction, information, and the like may be transmitted and received via a transmission medium. For example, when software is transmitted from a website, a server apparatus, or another remote source using at least one of a wired technology (such as coaxial cable, fiber optic cable, twisted pair, and DSL (Digital Subscriber Line)) and a wireless technology (such as infrared light and microwave), at least one of the wired and wireless technologies is included in the definition of the transmission medium.

(8) The terms “system” and “network” used in the foregoing embodiment are used interchangeably.

(9) Information, parameters, and the like described in the present disclosure may be expressed using absolute values, relative values from predetermined values, or other information corresponding thereto.

(10) In the foregoing embodiment, user devices 20-1 to 20-j may be mobile stations. There are cases in which, by persons skilled in the art, the mobile station is also referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or as some other suitable terms. In the present disclosure, terms such as “mobile station,” “user terminal,” “user equipment (UE),” and “terminal” may be used interchangeably.

(11) In the foregoing embodiment, the terms “connected,” “coupled,” or any variations thereof mean any direct or indirect connection or coupling between two or more elements and one or more intermediate elements may be present between two elements that are “connected” or “coupled” to each other. The coupling or connection between elements may be physical coupling or connection, logical coupling or connection, or a combination thereof. For example, “connection” may be rephrased as “access.” When such terms are used in the present disclosure, two elements are regarded to be “connected” or “coupled” to each other by using at least one of one or more wires, cables, and printed electrical connections, and as some non-limiting and non-exhaustive examples, by using electromagnetic energy having wavelengths in radio-frequency regions, microwave regions, and light (both visible and invisible) regions, and the like.

(12) In the foregoing embodiment, the description “based on” used in the present disclosure does not mean “based only on” unless explicitly stated otherwise. In other words, the description “based on” means both “based only on” and “based at least on.”

(13) The term “determining” or “determining” used in the present disclosure may encompass a wide variety of actions. “Determining” or “determining” may include regarding some actions such as judging, calculating, computing, processing, deriving, investigating, looking up, search, inquiry (for example, searching in a table, database, or other data structures), and ascertaining, as it has been “determined” or “determined.” Furthermore, “determining” or “determining” may also include regarding some actions such as receiving (for example, receiving information), transmitting (for example, transmitting information), input, output, and accessing (for example, accessing data in a memory), as it has been “determined” or “determined.” Furthermore, “determining” or “determining” may also include regarding some actions such as resolving, selecting, choosing, establishing, and comparing, as it has been “determined” or “determined.” That is, “determining” or “determining” may include regarding some actions have been “determined” or “determined.” In addition, “determining (determining)” may be rephrased as “assuming,” “expecting,” “considering,” and the like.

(14) In the foregoing embodiment, when “include,” “including,” and variations thereof are used, these terms are intended to be inclusive in a manner similar to the term “comprising.” The term “or” used in the present disclosure is intended not to be an exclusive OR.

(15) In the present disclosure, for example, during translation, if articles such as a, an, and the in English are added, the present disclosure may include a case in which a noun following these articles is plural.

(16) In the present disclosure, the term “A and B are different” may mean “A and B are different from each other.” Note that the term may also mean “A and B are each different from C.” Terms such as “leave,” “coupled,” or the like may also be interpreted in the same manner as “different.”

(17) Each aspect and embodiment in the present disclosure may be used separately or in combination, or may be used as they are switched in accordance with execution. Notification of predetermined information (for example, notification of “being X”) is not limited to being performed explicitly, and it may be performed implicitly (for example, not notifying the predetermined information).

Although the present disclosure has been described in detail above, it is apparent to those skilled in the art that the present disclosure is not limited to the embodiments described in the present disclosure. The present disclosure can be implemented as modifications and variations without departing from the spirit and scope of the present disclosure defined by the claims. Therefore, the description of the present disclosure is for the purpose of illustration and has no restrictive meaning to the present disclosure.

### DESCRIPTION OF REFERENCE SIGNS

1 . . . virtual space system, 10 . . . virtual space server, 11 . . . processing device, 20-1 to 20-j . . . user devices, 24 . . . display device, 111 . . . acquirer, 112 . . . manager, 113 . . . extractor, 114 . . . determiner, 115 . . . changer, 116 . . . display controller, 117 . . . mover, Ak . . . avatar, TBL 1 . . . user table, TBL2 . . . first facility table, and TBL3 . . . second facility table.

1. An avatar moving apparatus comprising:
a changer configured to change, when two or more facilities with the same facility name exist at a place at a destination of an avatar of a user specified by the user, the same facility name corresponding to the two or more facilities to two or more facility names that correspond one-to-one to the two or more facilities and differ from each other;
a display controller configured to display on a display device used by the user, a display image including the two or more facility names different from each other that have been changed by the changer; and
a mover configured to teleport, when the user has specified a first facility name included in the display image, the avatar of the user to a location corresponding to the first facility name.

2. The avatar moving apparatus according to claim 1, wherein the first facility name is specified by a voice of the user, a line of sight of the user, or an operation of the user onto a controller.

3. The avatar moving apparatus according to claim 1, wherein:
the display image is an image of a map, and
the image of the map comprises:
the two or more facility names that correspond one-to-one to the two or more facilities; and
two or more icons that correspond one-to-one to the two or more facilities.

4. The avatar moving apparatus according to claim 1, wherein each of the two or more facility names different from each other that have been changed by the changer includes the facility name before the change and a name of a manager of the facility.

5. The avatar moving apparatus according to claim 4, wherein the display image is an image representing a list of a plurality of the facility names corresponding one-to-one to a plurality of facilities arranged at the place on the destination of the avatar of the user.

6. The avatar moving apparatus according to claim 1, further comprising:
an extractor configured to extract a plurality of facility names of a plurality of facilities associated with the place based on first facility data that associates a facility name of a facility with a location of the facility for each of the facilities located in a virtual space; and
a determiner configured to determine whether the names of the facilities extracted by the extractor include the same facility name,
wherein the changer changes the same facility name to the two or more facility names that correspond one-to-one to the two or more facilities and differ from each other, when the determination result of the determiner is affirmative.

7. The avatar moving apparatus according to claim 6, further comprising a manager configured to manage second facility data and the first facility data, the second facility data associating the facility names of the two or more facilities different from each other changed by the changer with locations of the two or more facilities different from each other in a one-to-one manner,
wherein the mover identifies, when the first facility name is one of the two or more different facility names changed by the changer, the location of the facility corresponding to the first facility name based on the second facility data.
